(19) United States
(12) Patent Application Publication
(10) Pub. No.: US 2013/0061279 A1
(43) Pub. Date: Mar. 7, 2013

(54) DIGITAL BROADCAST RECEPTION DEVICE AND DIGITAL BROADCAST RECEPTION METHOD

(71) Applicant: Tatsuya Suzuki, Osaka (JP)

(72) Inventor: Tatsuya Suzuki, Osaka (JP)

(73) Assignee: PANASONIC CORPORATION, Kadoma-shi, Osaka (JP)

(21) Appl. No.: 13/697,530

(22) PCT Filed: May 11, 2011
(86) PCT No.: PCT/JP2011/002622

§ 371 Date: Nov. 13, 2012

(30) Foreign Application Priority Data
May 14, 2010 (JP) 2010-111717

(51) Int. Cl. H04N 21/00

(52) U.S. Cl. 725/131

(57) ABSTRACT

When an additional audio generation section (108) generates an audio for vocally reading out program information by using program information data extracted from a signal separation section (102), a control section (116) controls continuation or halt of vocal reading-out with respect to the additional audio generation section (108) on the basis of a channel selection instruction from a channel selection operation input section (115) and a state of vocal reading-out of the program information, and controls execution of program selection with respect to a reception tuning section (101) and the signal separation section (102).

### TECHNICAL FIELD

The present invention relates to a digital broadcast reception device and digital broadcast reception method that have functionality to vocally read out a content in an auxiliary screen on which program information is displayed, or a content of an electronic program guide (hereinafter, referred to as “EPG”), to inform a viewer of the content.

### BACKGROUND ART

In recent digital broadcast reception devices and broadcast recording devices which record TV broadcast programs, functionality to display program information of a broadcast program on a portion of a program screen as an auxiliary screen by using data signals that are multiplexed on a video-audio signal of the broadcast program and transmitted, and EPG functionality to display a program guide on the entire screen have become widely popularized and are built-in. These functionalities have the great benefits that the viewer can easily recognize programs being currently broadcasted or scheduled to be broadcasted later, without checking a program listing in a newspaper or magazine, and timer-viewing for preventing a program from being missed and timer-recording for recording a desired program in the absence of the viewer can be set by a simple operation.

Meanwhile, it is very difficult for a viewer having very poor eyesight or a visually impaired viewer to see an auxiliary screen or EPG screen in which relatively small characters are densely arranged, and these screens have poor usability.

Thus, in Patent Literature 1 and Patent Literature 2, the viewer's operability is improved by vocally reproducing program information used in an EPG. In other words, these documents propose that when the viewer causes the EPG screen to be displayed and performs an operation to select a specific program in the screen by cursor movement or the like, outline information of the selected program is displayed and also vocally reproduced from a loudspeaker.

### CITATION LIST

### Patent Literature

[PTL 1] Japanese Laid-Open Patent Publication No. 2000-324417
[PTL 2] Japanese Laid-Open Patent Publication No. 2000-125221

### SUMMARY OF THE INVENTION

### Problems to be Solved by the Invention

As described above, when the method in Patent Literature 1 or Patent Literature 2 is used, it is possible to provide an operation environment in which program information is obtained by hearing, without the reading of small characters in an EPG screen or the like, and thus is useful for the viewer.

However, with these methods, when a channel selection operation or a cursor position change operation is performed in the EPG screen during vocal reading out of the program information, an operation is generally performed in which the vocal reading-out is temporarily halted, shifting to vocal reading out of program information of another program.

For example, in FIG. 10, while a currently-selected program screen 401 is displayed on a display section 113 of a digital broadcast reception device, an auxiliary screen 402 is provided on which on-screen display of program information corresponding to the currently-selected program is displayed on the upper right of the display section 113. On the auxiliary screen 402, for example, the channel number, the broadcast station name, the title of the program, the start and end times, the outline of the program, and the like are displayed.

Simultaneously with displaying the auxiliary screen 402, vocal reading out of the displayed content is started by vocal-reading functionality. When, in the middle of the vocal reading-out, the user performs a channel selection operation to select a program of another broadcast station, the program screen 401 on the display section 113 and the program information on the auxiliary screen 402 are changed to contents of the newly-selected program. With regard to vocal reading-out, with the update of the auxiliary screen 402, vocal reading out of the new program information on the auxiliary screen 402 is started.

In general, as compared to the time taken to visually read displayed character information, the time taken to vocally read out the character information is long. Thus, at the time when the auxiliary screen 402 is felt to be almost comprehended through a glance at the auxiliary screen 402 and a channel selection operation to another broadcast station is performed, vocal reading out of the auxiliary screen 402 often has not been completed and is still being performed. In visual reading, an oversight or misreading is likely to occur. On the other hand, in hearing voice, all the text is always vocally read out and the speed of the vocal reading-out is lower than that of the visual reading, and thus the possibility of missing a word or mishearing is low. Thus, immediately before feeling visual comprehension and performing an operation to shift to the next channel, importance and high interest of a program is noticed by hearing a vocally read-out content, and necessity arises to change behavior to attempt to hear the content until the end. However, a situation occurs in which a channel selection operation precedes and, after selection of a new program, an operation to return to the immediately previous program again has to be performed.

The same problem also occurs in the case where the user performs channel selection by using EPG functionality. In other words, in such a case, an EPG screen 403 is displayed on the display section 113 as shown in FIG. 11, for example, a program C2 selected by a cursor 404 is highlighted, and program information of the program C2 is vocally read out. When the user selects a program of another broadcast station by cursor movement in the middle of the vocal reading-out of the program information of the program C2, vocal reading-out of program information of the newly-selected program is started before the vocal reading-out of the program information of the program C2 ends.

The case where vocal reading-out is temporarily halted includes not only the above case where a channel selection operation is performed by the user but also the following cases. There is a case where, due to emergency broadcast or the like in the middle of broadcasting, an interrupt audio is provided or the channel is forced to be changed to another station. There is also a case where, in a digital broadcast reception device having recording functionality, when a time to which timer-recording is set has come, a currently-viewed program is changed to a program for which the timer-recording is set. As another example, vocal reading-out is temporarily halted when the user switches broadcast program viewing to a video signal from, for example, a DVD player or a cable television reception device through an input switching operation of the digital broadcast reception device.

The present invention has been made in order to solve such problems, and an object of the present invention is to provide a digital broadcast reception device and digital broadcast reception method that allow minimum necessary program information to be always vocally read out even when a new channel selection operation is performed during vocal reading-out of program information displayed on an auxiliary screen, an EPG, or the like.

### Solution to the Problems

In order to attain the object described above, a digital broadcast reception device according to a first aspect of the present invention includes: a reception tuning section configured to select a broadcast signal; a signal separation section configured to separate the selected broadcast signal into program video data, program audio data, and program information data representing program information; a video decoder section configured to decode the program video data and output a program video signal; an audio decoder section configured to decode the program audio data and output a program audio signal; a storage section configured to administer the program information data such that a priority is assigned to each item in the program information data as a priority-based group; an additional audio generation section configured to generate a reading audio of the program information by using the program information data; an additional image generation section configured to generate a program information image by using the program information data; an audio synthesizing section configured to synthesize and output the program audio signal and the reading audio of the program information; a video synthesizing section configured to synthesize and output the program video signal and the program information image; a channel selection operation input section configured to receive input of a channel selection operation by a user; and a control section configured to determine whether or not a priority-based group of a determined priority or higher in program information data of a currently-viewed program has been outputted as a reading audio of the program information from the additional audio generation section when a channel selection operation for switching the currently-viewed program to another program other than the currently-viewed program is inputted into the channel selection operation input section, and control continuation or halt of output of the reading audio of the program information of the currently-viewed program in accordance with a result of the determination.

Because of this, even when a display is switched to another video content during vocal reading-out of program information, program information reading functionality to ensure an opportunity for vocally reading out important information in the program information can be realized.

In addition, in a digital broadcast reception device according to a second aspect of the present invention based on the digital broadcast reception device according to the first aspect of the present invention, while the additional audio generation section vocally reads out an item in the priority-based group of the determined priority or higher, the control section performs control so as to hold the channel selection operation to the other program on the channel selection operation input section until vocal reading-out of all items in the priority-based group of the determined priority or higher is ended.

Because of this, even when a channel selection operation to shift to another program is performed during vocal reading-out of program information, the vocal reading-out can be preferentially performed until a good break point.

In addition, a digital broadcast reception device according to a third aspect of the present invention based on the digital broadcast reception device according to the first aspect of the present invention further includes a timer-recording control section having timer-viewing functionality or timer-recording functionality, and, when, during vocal reading-out of the program information data of the currently-viewed program, the currently-viewed program is switched by the timer-recording control section to a program for which timer-viewing is set or a program for which timer-recording is set, the control section temporarily halts the vocal reading-out of the program information data of the currently-viewed program, and restarts the vocal reading-out of the program information data of the currently-viewed program after end of vocal reading-out of program information data corresponding to the program for which timer-viewing is set or the program for which timer-recording is set.

Because of this, even when switching to a program for which timer-recording is set is performed during vocal reading-out of program information, change to vocal reading-out of the program for which the timer-recording is set is performed, but then, the vocal reading-out of the original program information can be returned to and completed.

In addition, a digital broadcast reception device according to a fourth aspect of the present invention based on the digital broadcast reception device according to the first aspect of the present invention further includes an inter-device communication control section configured to receive input of a video signal from an external device, and, when, during vocal reading-out of the program information data of the currently-viewed program, the currently-viewed program is switched by the inter-device communication control section to the video signal from the external device, the control section temporarily halts the vocal reading-out of the program information data of the currently-viewed program, and restarts the vocal reading-out of the program information data of the currently-viewed program after end of vocal reading-out of determined information corresponding to the video signal from the external device.

Because of this, even when switching to external video input of the digital broadcast reception device is performed during vocal reading-out of program information, change to vocal reading-out of the external video device name or the like is performed, but then, the vocal reading-out of the original program information can be returned to and completed.

A digital broadcast reception method according to a fifth aspect of the present invention includes: a reception tuning step of selecting a broadcast signal; a signal separation step of separating the broadcast signal into program video data, program audio data, and program information data representing program information; a storage step of administering the program information data such that a priority is assigned to each item in the program information data as a priority-based group; an additional audio generation step of generating a reading audio of the program information by using the program information data; an additional image generation step of generating a program information image by using the program information data; an audio synthesizing step of synthesizing and outputting the program audio signal and the reading audio of the program information; a video synthesizing step of synthesizing and outputting the program video signal and the program information image; a channel selection operation input step of receiving input of a channel selection operation by a user; and a control step of determining whether or not a priority-based group of a determined priority or higher in program information data of a currently-viewed program has been outputted as a reading audio of the program information at the additional audio generation step when a channel selection operation for switching the currently-viewed program to another program other than the currently-viewed program is inputted at the channel selection operation input step, and controlling continuation or halt of output of the reading audio of the program information of the currently-viewed program in accordance with a result of the determination.

In addition, in a digital broadcast reception method according to a sixth aspect of the present invention based on the digital broadcast reception method according to the fifth aspect of the present invention, during vocal reading-out of an item in the priority-based group of the determined priority or higher at the additional audio generation step, the control step performs control so as to hold the channel selection operation to the other program at the channel selection operation input step until vocal reading-out of all items in the priority-based group of the determined priority or higher is ended.

In addition, a digital broadcast reception method according to a seventh aspect of the present invention based on the digital broadcast reception method according to the fifth aspect of the present invention further includes a timer-recording control step having timer-viewing functionality or timer-recording functionality, and, when, during vocal reading-out of the program information data of the currently-viewed program, the currently-viewed program is switched at the timer-recording control step to a program for which timer-viewing is set or a program for which timer-recording is set, the control step temporarily halts the vocal reading-out of the program information data of the currently-viewed program, and restarts the vocal reading-out of the program information data of the currently-viewed program after end of vocal reading-out of program information data corresponding to the program for which timer-viewing is set or the program for which timer-recording is set.

In addition, a digital broadcast reception method according to an eighth aspect of the present invention based on the digital broadcast reception method according to the fifth aspect of the present invention further includes an inter-device communication control step of receiving input of a video signal from an external device, and, when, during vocal reading-out of the program information data of the currently-viewed program, the currently-viewed program is switched at the inter-device communication control step to the video signal from the external device, the control step temporarily halts the vocal reading-out of the program information data of the currently-viewed program, and restarts the vocal reading-out of the program information data of the currently-viewed program after end of vocal reading-out of determined information corresponding to the video signal from the external device.

### Advantageous Effects of the Invention

According to the present invention, even when a new channel selection operation is performed during vocal reading-out of program information displayed on an auxiliary screen, an EPG, or the like, minimum necessary program information is allowed to be vocally read.

### BRIEF DESCRIPTION OF THE DRAWINGS

FIG. 1 is a block diagram showing an example of the configuration of a digital broadcast reception device according to Embodiment 1 of the present invention.

FIG. 2 is a flowchart showing an operation of the digital broadcast reception device according to Embodiment 1 of the present invention.

FIG. 3 is a diagram showing the data structure of a TS in digital broadcast.

FIG. 4 is a diagram showing the data structure of service information among program information data in digital broadcast.

FIG. 5 is a diagram showing the data structure of program-related information among the program information data in digital broadcast.

FIG. 6 is a block diagram showing an example of the configuration of a digital broadcast reception device according to Embodiment 2 of the present invention.

FIG. 7 is a flowchart showing an operation of the digital broadcast reception device according to Embodiment 2 of the present invention.

FIG. 8 is a block diagram showing an example of the configuration of a digital broadcast reception device according to Embodiment 3 of the present invention.

FIG. 9 is a flowchart showing an operation of the digital broadcast reception device according to Embodiment 3 of the present invention.

FIG. 10 is a conceptual diagram of an auxiliary screen that displays program information.

FIG. 11 is a conceptual diagram of an EPG screen that displays program information.

### DESCRIPTION OF EMBODIMENTS

Hereinafter, digital broadcast reception devices according to embodiments of the present invention will be described with reference to the drawings.

### Embodiment 1

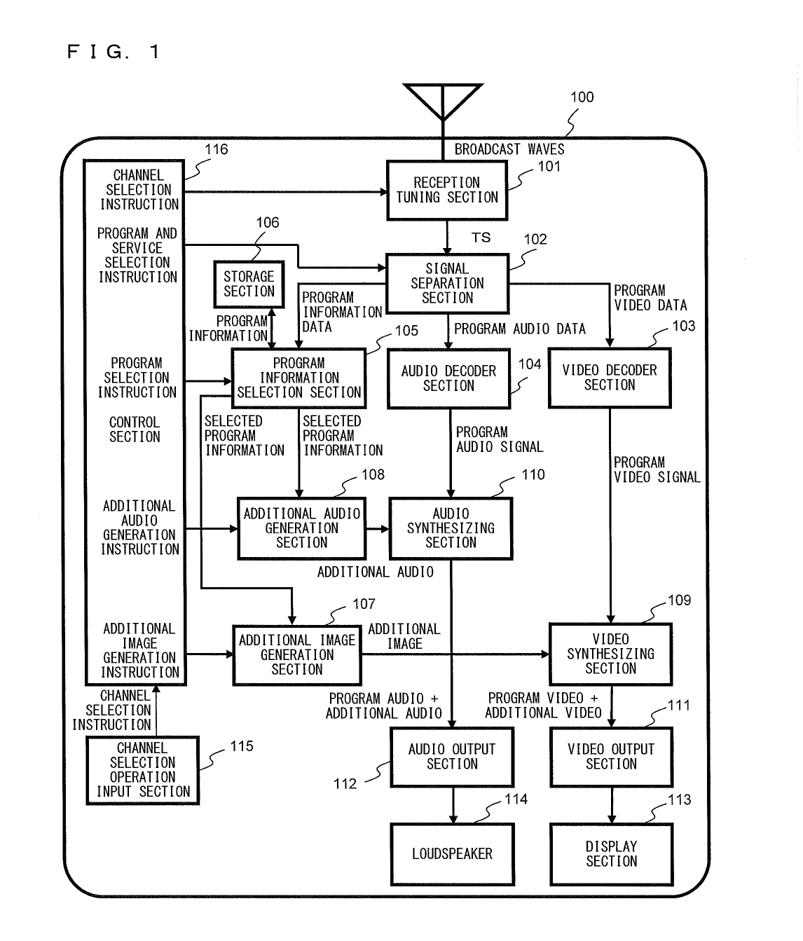

FIG. 1 is a block diagram showing an example of the configuration of a digital broadcast reception device 100 according to Embodiment 1 of the present invention. The digital broadcast reception device 100 includes a reception tuning section 101, a signal separation section 102, a video decoder section 103, an audio decoder section 104, a program information selection section 105, a storage section 106, an additional image generation section 107, an additional audio generation section 108, a video synthesizing section 109, an audio synthesizing section 110, a video output section 111, an audio output section 112, a display section 113, a loudspeaker 114, a channel selection operation input section 115, and a control section 116.

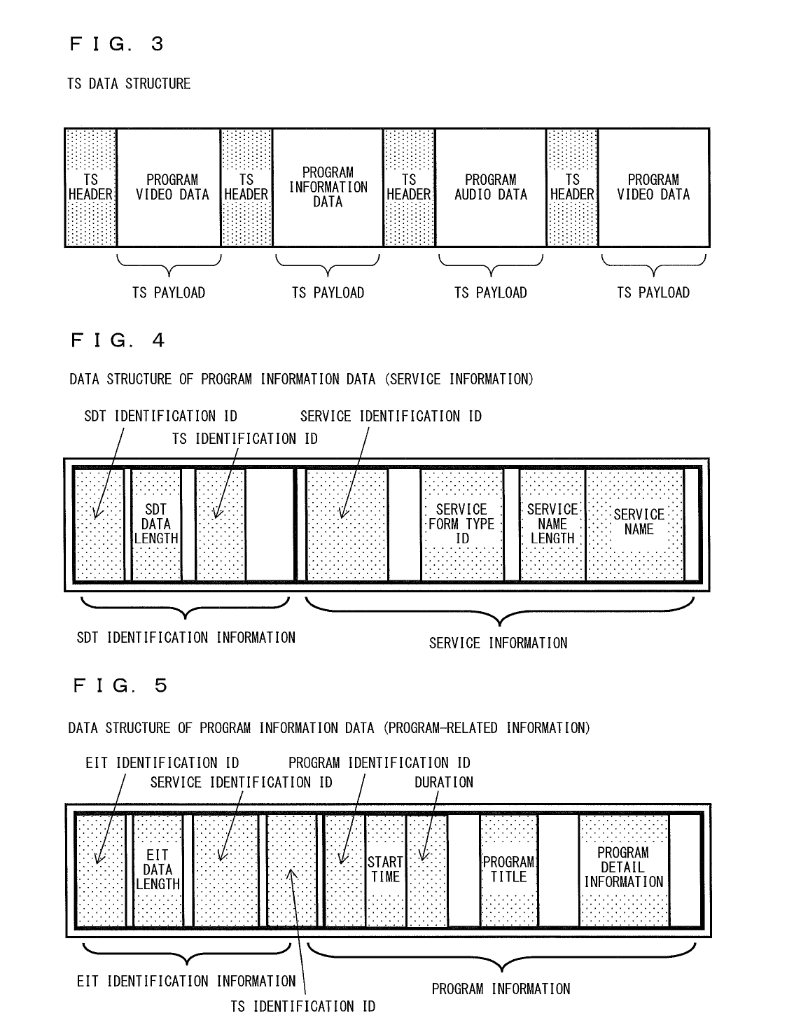

Received broadcast waves are subjected to high-frequency amplification, tuning, demodulation in the reception tuning section 101, and a transport stream (hereinafter, referred to as “TS”) which is a digital signal stream is outputted. As shown in FIG. 3, the TS is composed of a TS header portion and a TS payload portion, and the TS payload portion includes program video data, program audio data, and program information data of a broadcast program and is transmitted.

The TS is separated into the program video data, the program audio data, and the program information data in the signal separation section 102. Among them, the program video data is outputted as an uncompressed digital video signal (program video signal) to the video decoder section 103. Similarly, the program audio data is outputted as an uncompressed digital audio signal (program audio signal) to the audio decoder section 104. In digital television broadcast in Japan, MPEG is mainly used for compression of video and audio. Thus, the video decoder section 103 and the audio decoder section 104 are normally MPEG type decoders.

The program information data extracted from the signal separation section 102 is composed of service information and program-related information, and the detailed data structures thereof are shown in FIGS. 4 and 5. First, the data structure of the service information is shown in FIG. 4. The service information is entirely composed of an SDT (Service Description Table) identification information portion and a service information portion. The SDT identification information is data that defines information related to a service included in the TS. The SDT identification information portion is composed of an SDT identification ID and an SDT data length as well as a subsequent TS identification ID. The service information is composed of a service identification ID, a service form type ID (ID identifying the type of the service (a television broadcast service, a data broadcast service, etc.), a service name length, a service name, and the like.

Next, the data configuration of the program-related information is shown in FIG. 5. The program-related information is entirely composed of an EIT (Event Information Table) identification information portion and a program information portion. The EIT identification information is data that defines information related to a program included in the service. The EIT identification information portion is composed of an EIT identification ID and an EIT data length as well as a subsequent service identification ID (ID for distinguishing and identifying the service) and a subsequent TS identification ID. The program information is composed of a program identification ID, a start time, duration, a program title, program detail information, and the like.

As the program information data, program information corresponding to a channel selection operation of the user is selected in the program information selection section 105. In addition, the program information is stored in the storage section 106. The additional image generation section 107 generates an additional image that is mainly composed of character information, on the basis of the selected program information. The additional audio generation section 108 generates an additional audio for reading the program information, on the basis of the selected program information.

The video synthesizing section 109 synthesizes program video and an additional image. Here, the synthesizing refers to functionality to multiplex signals of both or functionality to switch between both and select and output either one of both. The audio synthesizing section 110 synthesizes a program audio and an additional audio. Here, similarly to the case of video, the synthesizing refers to functionality to multiplex signals of both or functionality to switch between both and select and output either one of both.

The video output section 111 converts a video signal (program video+additional video) from the video synthesizing section 109 into a determined display format and outputs the video signal to the display section 113. The display section 113 is a display device, and, for example, a liquid crystal display panel or a plasma display panel is used. The audio output section 112 converts an audio signal (program audio+additional audio) from the audio synthesizing section 110 into an analog signal, amplifies the analog signal, and outputs the analog signal to the loudspeaker 114 which is a sound reproduction section. The loudspeaker 114 may be a single loudspeaker, but in many cases, a combination of a plurality of loudspeaker units for stereo reproduction or stereophonic reproduction is used.

The channel selection operation input section 115 is an input means for selecting a desired broadcast station by user operation, and in many cases, a remote control unit accompanying the digital broadcast reception device 100 is used. In this case, it is technically appropriate that the channel selection operation input section 115 is illustrated outside the digital broadcast reception device 100, but the channel selection operation input section 115 is illustrated within the device, since its functionality is a part of the functionality of the digital broadcast reception device 100.

The control section 116 controls the reception tuning section 101, the signal separation section 102, the program information selection section 105, the additional image generation section 107, and the additional audio generation section 108. The control section 116 is realized by a so-called microprocessor. In the actual digital broadcast reception device 100, the control section 116 is responsible for functionality regarding many controls within the device, but only functionality regarding the present invention is described herein.

Operation of the digital broadcast reception device 100 with the configuration described above will be described. The user operates the channel selection operation input section 115 to select a desired channel, namely, a desired broadcast station. The channel selection operation is performed normally by a numeric key pressing button operation or an up-down button operation. Alternatively, the channel selection operation is performed by a cursor operation in a display screen of an EPG generated by using program information obtained from broadcast waves. Although there is no need to describe the EPG in detail since the EPG has already been widely popularized, the EPG refers to a screen in which a display like a television program listing in a newspaper is displayed on the screen of the digital broadcast reception device 100 and functionality to perform channel selection by selecting a program in the display with a cursor or to set timer-viewing or timer-recording is provided.

The control section 116 reads the content of an operation on the channel selection operation input section 115 and controls a tuning operation of the reception tuning section 101 and a separation operation of the signal separation section 102. The reason why program selection is controlled on the signal separation section 102 is that since there is a case where a plurality of programs are included in one TS, an operation in the signal separation section 102 is used for selecting one program among them. In addition, similarly, the reason why an instruction of service selection is made to the signal separation section 102 is that the types of desired broadcast contents to be reproduced include not only normal television broadcast but also audio-only broadcast and data broadcast, and data in a TS to be actually used is different among them.

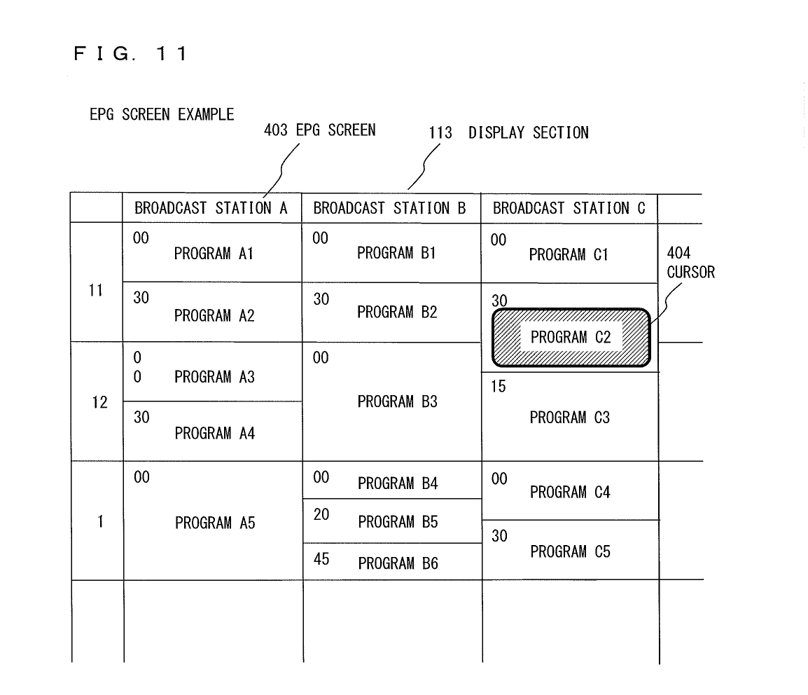

The program video data and the program audio data separated by the signal separation section 102 are demodulated by the video decoder section 103 and the audio decoder section 104, respectively. Meanwhile, the program information data normally includes program information of all broadcast stations for several days in order to generate an EPG screen, and thus is stored once in the storage section 106. In the program information selection section 105, information corresponding to a designated program among the stored program information is selected. On the basis of the selected program information, an image to be displayed on the display section 113 is generated in the additional image generation section 107. As described above, in the case where program information of a specific program is superimposed on a program video display, a display of the auxiliary screen 402 as illustrated in FIG. 10 is provided. In addition, in the case where the EPG screen 403 is displayed, highlighting is performed by a method such as changing the color of the background at a selected program, as shown in FIG. 11.

Meanwhile, with regard to audio, an audio for reading through the loudspeaker 114 is generated in the additional audio generation section 108 on the basis of the selected program information.

The generated additional image and additional audio are synthesized by the video synthesizing section 109 and the audio synthesizing section 110, respectively, and outputted via the video output section 111 and the audio output section 112 to the display section 113 and the loudspeaker 114, respectively. The video signal synthesizing includes the case of multiplexing as in FIG. 10 and the case of switching and displaying an EPG as in FIG. 11. However, in the case of audio, switching to an additional audio is generally performed and the additional audio is reproduced through the loudspeaker, since a multiplexed audio is difficult to hear. It is noted that other than a method of switching between a program audio and an additional audio, a program audio and an additional audio may be synthesized in a determined volume ratio and outputted as a synthesized audio through the loudspeaker.

As described above, when a specific program is selected with the channel selection operation input section 115, program information of the program is displayed and vocal reading-out of the program information is started through the loudspeaker 114. When the vocal reading-out is started and completed and then a next channel selection operation is performed, the aforementioned operation suffices to be merely executed similarly for a newly-selected program. However, when a new channel selection operation is performed in the middle of the vocal reading-out, it is necessary to appropriately halt or continue the vocal reading-out.

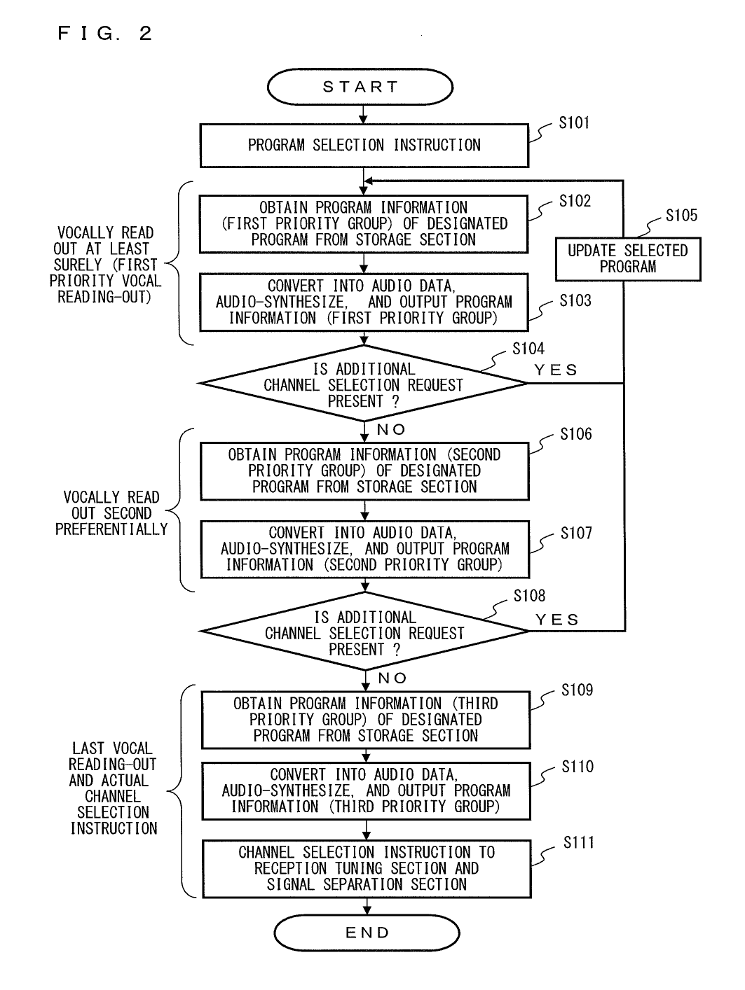

FIG. 2 shows a flowchart regarding vocal reading-out control of the digital broadcast reception device 100 according to the present embodiment. First, prior to starting an operation of the flowchart, items in program information to be vocally read out are previously classified into several groups. The groups are formed by classifying items included in program information according to priorities determined on the basis of assumed importance to the user. The priorities may be previously set according to importance of notification to the user, or may be freely changed and set, for example, according to a usage situation of the user. In FIG. 2, classification into three groups is assumed. For example, a classification is arranged such that “broadcast station name” is assigned to a first priority group, “program title” and “broadcast start and end times” are assigned to a second priority group, and “performer” and “program outline” are assigned to a third priority group. The classification defined thus is previously set in the control section 116, and it suffices that each time program information is inputted from broadcast waves, a classification is arranged and stored in the storage section 106.

In FIG. 2, when the user selects a desired program at step S101, the items of the first priority group among the designated program information are obtained from the storage section 106 at step S102. Here, the selection of a program by the user is performed, for example, by an input of a channel number, a channel up-down operation, or cursor movement in the EPG screen 403 shown in FIG. 11. Next, the items of the first priority group are converted into audio data and vocally read out at step S103. Then, at step S104, it is detected whether an additional channel selection request is present. When a channel selection request is present (in the case of “YES”), the designated program is updated at step S105 and the processing returns to step S101 to obtain program information of a new program. Because of this procedure, the processing does not proceed to vocal reading-out of the program information of the new program until the vocal reading-out of the items of the first priority group ends. Thus, the items of the highest priority are assuredly vocally read out without any halt.

When no channel selection request is present at step S104 (in the case of “NO”), the items of the second priority group are subsequently vocally read out through steps S106, S107, and S108. Similarly to the case of vocal reading-out of the first priority group, once the vocal reading-out of this group is started, detection of new channel selection request is not performed until completion of the vocal reading-out. Thus, the items of the second priority group are vocally read out without any halt. When a channel selection request is present at step S108 (in the case of “YES”), the designated program is updated at step S105 and the processing returns to step S101 to obtain program information of a new program.

When no channel selection request is present at step S108 (in the case of “NO”), the items of the third priority group are vocally read out through steps S109 and S110, and vocal reading-out of all the items in the program information is completed. At that time, the processing proceeds to step S111 where an instruction of channel selection or service selection is issued to the reception tuning section 101 and the signal separation section 102.

In other words, at that time, a new broadcast program is reproduced from the display section 113 and the loudspeaker 114. The channel update at step S105 is not reflected in an actual tuning-in operation, and merely program information of a new program is obtained. As an example, in the case of an operation in the EPG screen 403 in FIG. 11, the channel update is reflected in an operation of moving the cursor 404, and vocal reading-out is performed in accordance with the operation. However, when step S111 is executed, update of broadcast station and program is performed and new video and audio are actually reproduced.

The flowchart in FIG. 2 is intended to describe functionality regarding vocal reading-out of program information. Thus, a display of program information is not illustrated, but, for example, the display of the auxiliary screen 402 in FIG. 10 and the cursor position in the EPG screen in FIG. 11 are changed with update of the selected program.

As described above, according to the digital broadcast reception device 100 of the present embodiment, even in the case where a new channel selection operation is performed during vocal reading-out of program information displayed in an auxiliary screen, an EPG, or the like, minimum necessary program information is enabled to be vocally read.

It is noted that the items in program information to be vocally read out are classified into three groups with different priorities in Embodiment 1 described above, but this is merely an example and the number of groups is not limited thereto. In addition, the user may be allowed to designate what is prioritized.

### Embodiment 2

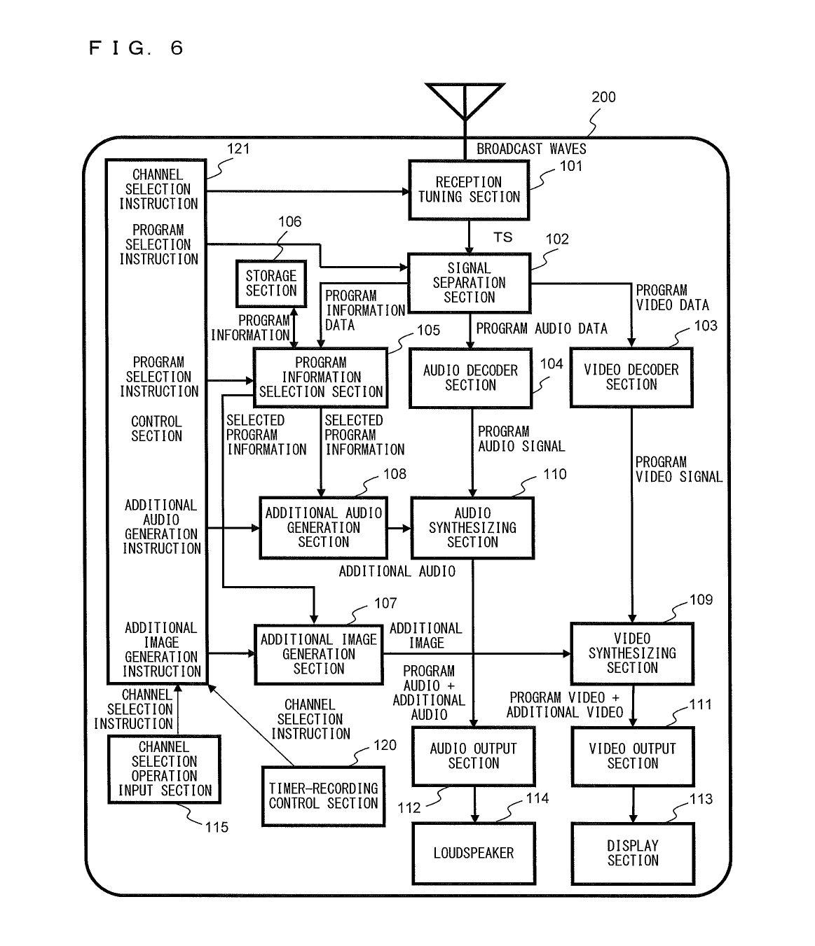

FIG. 6 is a block diagram showing an example of the configuration of a digital broadcast reception device 200 according to Embodiment 2 of the present invention. The digital broadcast reception device 200 is equipped with timer-recording functionality (including timer-viewing functionality) and has the same configuration as that of the digital broadcast reception device 100 in FIG. 1 described in Embodiment 1, except that a timer-recording control section 120 is added and the control section 116 is changed to a control section 121 for performing control including control functionality regarding an operation of the timer-recording control section 120. Here, the same configuration as that of the digital broadcast reception device 100 has the same functionality and thus the description thereof is omitted, and the configuration different from that of the digital broadcast reception device 100 will be described in detail.

When a time to which timer-recording or timer-viewing (hereinafter, described as timer-recording including timer-viewing) is set has come while the additional audio generation section 108 generates an additional audio for program information of a program, namely, while the program information is vocally read out, the timer-recording control section 120 outputs a channel selection instruction to the control section 121 for selecting the program for which the timer-recording is set. The timer-recording functionality has to be activated exactly at the set time. Thus, the control section 121 halts the vocal reading-out of the program information of the current program in the additional audio generation section 108. At the same time, a reading halt flag indicating that the vocal reading-out is halted is stored in the storage section 106.

Subsequently, the control section 121 controls the reception tuning section 101 and the signal separation section 102 according to the channel selection instruction from the timer-recording control section 120. As a result, reception and reproduction of the program for which the timer-recording is set is started, and program information of the program for which the timer-recording is set is read out from the storage section 106, accordingly. The program information of the (selected) program for which the timer-recording is set is outputted from the program information selection section 105, and an image thereof is generated by the additional image generation section 107 and displayed, while the program information is outputted from the additional audio generation section 108 and vocally read out. When the vocal reading-out ends, the control section 121 detects whether a reading halt flag has been stored in the storage section 106. When a reading halt flag has been stored, vocal reading-out of the program information of the program that has been vocally read out immediately before tuning into the program for which the timer-recording is set is restarted from the item at which the temporary halt is made. Thus, even when vocal reading-out of program information which is started to be vocally read out is once halted due to the timer-recording functionality, the vocal reading-out of the program information can be restarted and completed after the halt.

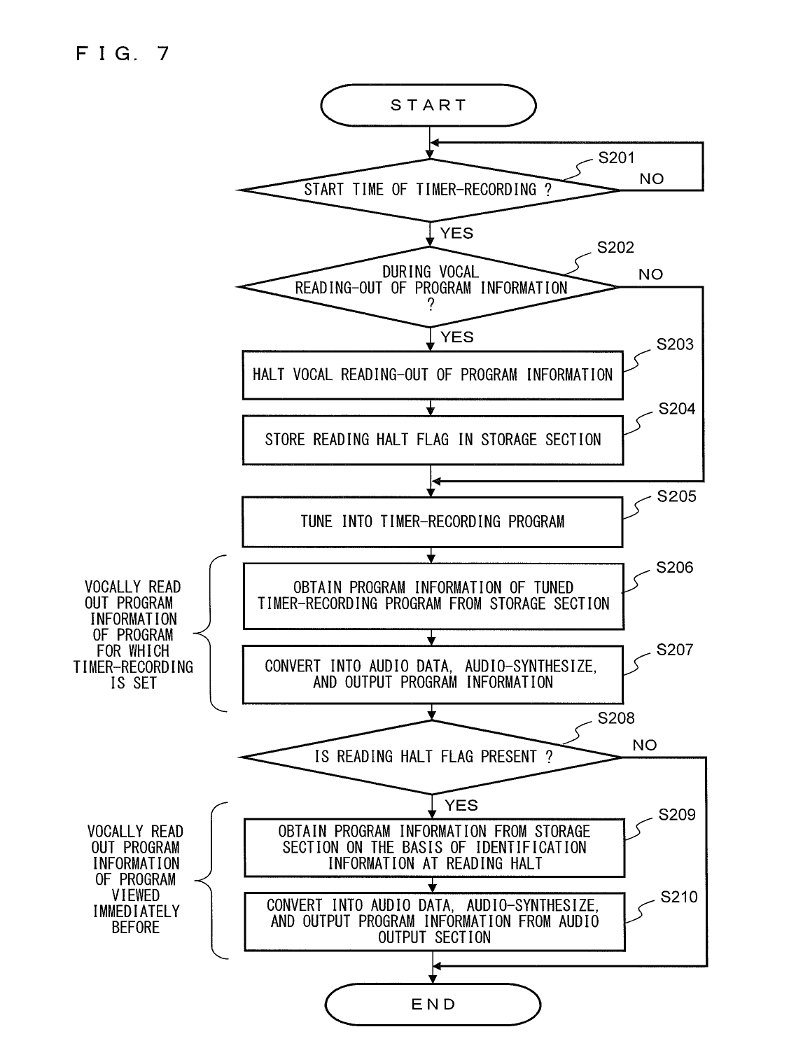

FIG. 7 is a flowchart illustrating a program information reading operation of the digital broadcast reception device 200 with the exemplary configuration in FIG. 6. At step S201, it is detected whether a set timer-recording time has come. When the timer-recording time has come (in the case of “YES” at step S201), it is detected at step S202 whether or not it is during vocal reading-out of program information. When it is during vocal reading-out (the case of “YES” at step S202), the vocal reading-out is halted at step S203, then a reading halt flag for recording the halt of the vocal reading-out is stored in the storage section 106 at step S204, and the processing proceeds to step S205 to tune into the program for which the timer-recording is set. When it is not during vocal reading-out at step S202 (in the case of “NO”), nothing is performed and the processing proceeds to step S205 to tune into the program for which the timer-recording is set. Here, when the reading halt flag includes a program identification ID and a service identification ID of the halted program and information of the time of the halt, it is convenient at a time of vocal reading-out restart described later.

Next, the processing proceeds to step S206 where program information of the program for which the timer-recording is set is obtained from the storage section 106. At step S207, vocal reading-out of the program information is started on the basis of the obtained program information. When the vocal reading-out of the program information of the timer-recording program ends, the processing proceeds to step S208 where it is detected whether a reading halt flag has been stored. When a reading halt flag has been stored (in the case of “YES” at step S208), it indicates that vocal reading-out of program information of a program that has been viewed immediately before viewing the timer-recording program is halted in its middle. Thus, at step S209, the program information of the original program is obtained from the storage section 106 again, vocal reading-out thereof is performed at step S210. When no reading halt flag has been stored (in the case of “NO” at step S208), it indicates that the vocal reading-out of the program information of the program that has been viewed immediately before viewing the timer-recording program has not been halted in its middle. Thus, the processing is ended without performing anything.

As described above, according to the digital broadcast reception device 200 of the present embodiment, even in the case where tuning into a timer-recording program, a kind of an interruption operation, occurs and vocal reading-out of program information is temporarily halted, when vocal reading-out of program information of the timer-recording program ends, the vocal reading-out of the program information of the original program can be restarted to prevent missing of any item to be vocally read out.

It is noted that in Embodiment 2 described above, the description has been given on the assumption that a target for restart of program information vocal reading-out of the original program is the entire program information, but as described in the procedure in FIG. 2 in Embodiment 1, items constituting program information may be divided into priority groups and completion of vocal reading-out to any priority group may be a target.

### Embodiment 3

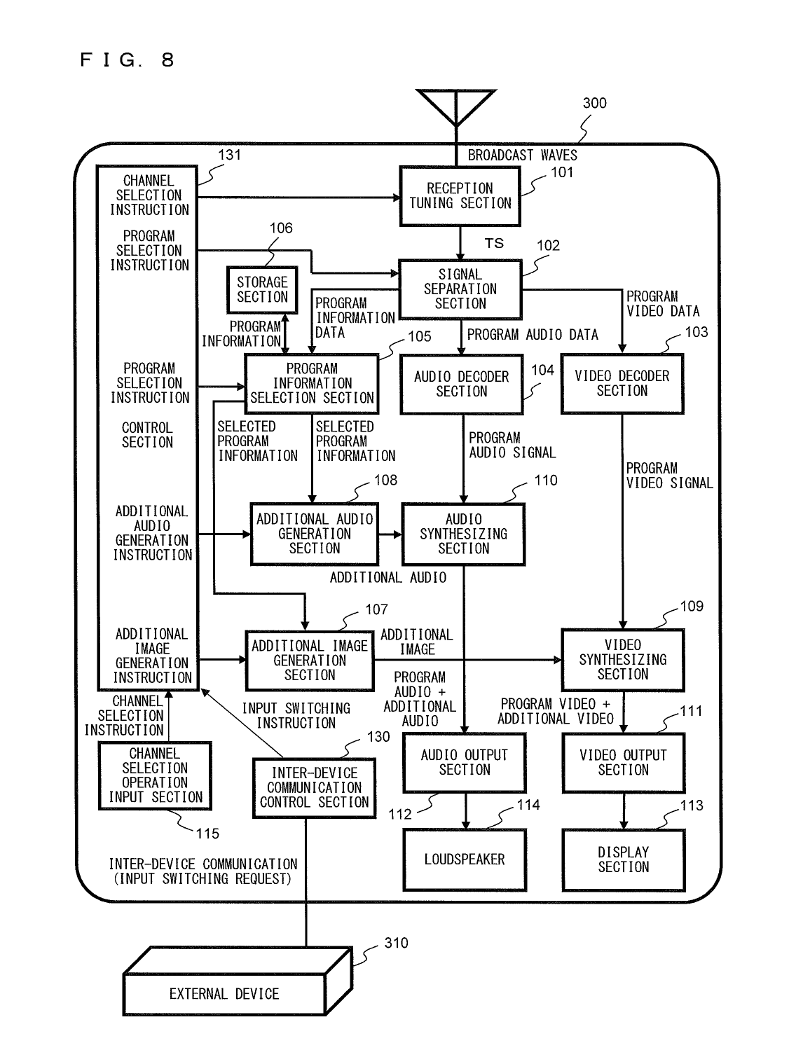

FIG. 8 is a block diagram showing an example of the configuration of a digital broadcast reception device 300 according to Embodiment 3 of the present invention. The digital broadcast reception device 300 is equipped with functionality to receive input of a video content from an external device and has the same configuration as that of the digital broadcast reception device 100 in FIG. 1 described in Embodiment 1, except that an inter-device communication control section 130 is added and the control section 116 is changed to a control section 131 for performing control including control functionality regarding an operation of the inter-device communication control section 130. Here, the same configuration as that of the digital broadcast reception device 100 has the same functionality and thus the description thereof is omitted, and the configuration different from that of the digital broadcast reception device 100 will be described in detail.

In the case of switching to video/audio input from an external device 310 (e.g., a DVD player) while the additional audio generation section 108 generates an additional audio for program information of a program, namely, while the program information is vocally read out, the inter-device communication control section 130 outputs an input switching instruction to the control section 131 for selecting the input video/audio. The input switching to the external device 310 has to be performed in response to the switching instruction in a short time. Thus, the control section 131 halts the vocal reading-out of the program information of the current program in the additional audio generation section 108. At the same time, a reading halt flag indicating the vocal reading-out is halted is stored in the storage section 106.

Subsequently, the control section 131 controls the signal separation section 102 in accordance with the input switching instruction from the inter-device communication control section 130. In other words, the signal separation section 102 receives and separates a TS or PS (Program Stream) from the external device 310, not a TS of a broadcast signal. As a result, reproduce of externally-inputted video/audio is started. In the case of a content by video/audio input from the external device 310, in general, program information is not included as in broadcast waves. It is appropriate to display and vocally read out from what external device the content has come, not to display and vocally read out program information. For example, a DVD player, a hard-disk-type video recorder, a video camera, a personal computer, a receiver dedicated for cable television, a satellite broadcast receiver, and the like are exemplified. In addition, it is possible to vocally read out the name of a connection means, not the name of the external device. For connection between the external device 310 and the digital broadcast reception device 300, a connection cord for analog video/audio, connection of the IEEE1394 standards, HDMI (High-Definition Multimedia Interface), an Ethernet (registered trademark) cable, or IP connection via a wireless LAN is used, and thus such a connection name may be vocally read out.

The name of the selected external device 310 or the name of the connection means is outputted from the inter-device communication control section 130 and an image thereof is generated by the additional image generation section 107 and displayed, while the name is outputted from the additional audio generation section 108 and vocally read out. When the vocal reading-out ends, the control section 131 detects whether a reading halt flag has been stored in the storage section 106. When a reading halt flag has been stored, vocal reading-out of the program information of the program that has been vocally read out immediately before the input switching is restarted from the item at which the temporary halt is made. Thus, even when vocal reading-out of program information which is started to be vocally read out is once halted due to the input switching functionality, the vocal reading-out of the program information can be restarted and completed after the halt.

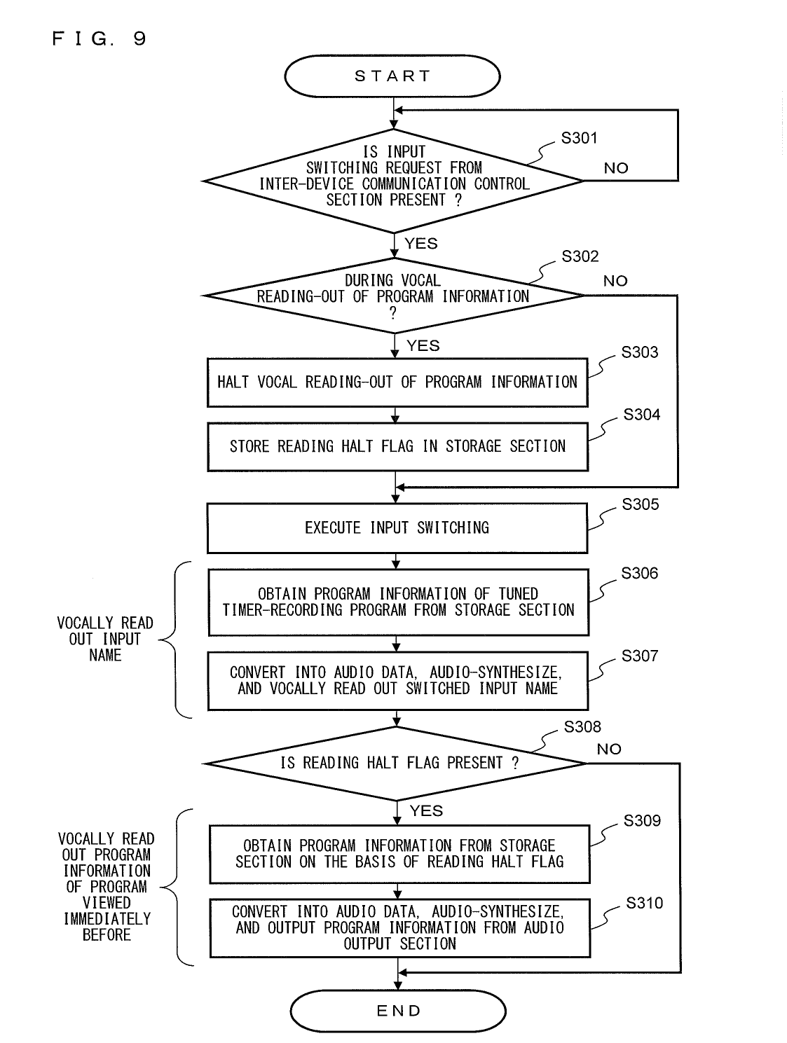

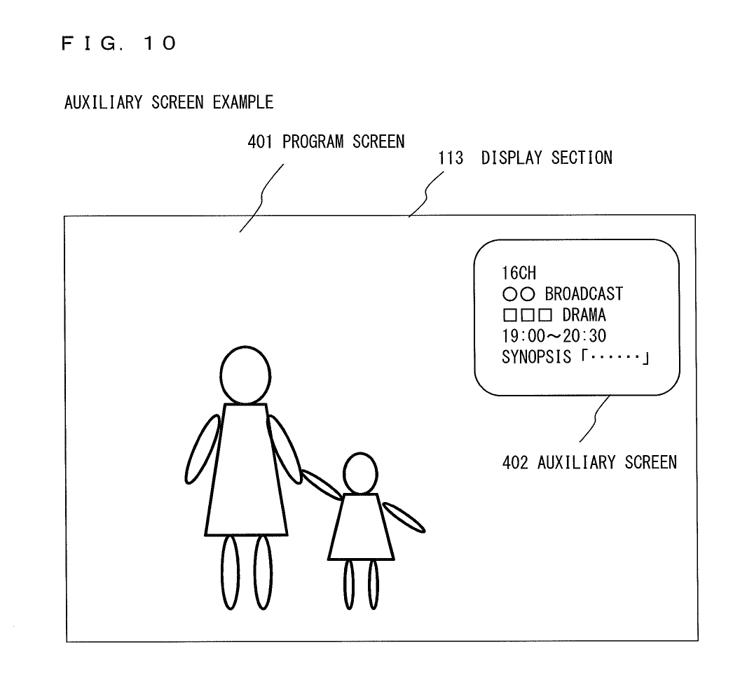

FIG. 9 is a flowchart illustrating a program information reading operation of the digital broadcast reception device 300 with the exemplary configuration in FIG. 8. At step S301, it is detected whether an input switching request is present. When a switching request is present (in the case of “YES” at step S301), it is detected at step S302 whether or not it is during vocal reading-out of program information. When it is during vocal reading-out (the case of “YES” at step S302), the vocal reading-out is halted at step S303, then a reading halt flag for recording the halt of the vocal reading-out is stored in the storage section 106 at step S304, and the processing proceeds to step S305 to tune into a program for which timer-recording is set. When it is not during vocal reading-out at step S302 (in the case of “NO”), nothing is performed and the processing proceeds to step S305 to select the switched video/audio input. The content of the reading halt flag is the same as that described for the illustration of FIG. 7.

Next, the processing proceeds to step S306 where the name of the external device 310 or the external device connection means is obtained from the inter-device communication control section 130. At step S307, vocal reading-out of the name is performed on the basis of the obtained name. When the vocal reading-out of the name of the external device 310 or the external device connection means ends, the processing proceeds to step S308 where it is detected whether a reading halt flag has been stored. When a reading halt flag has been stored (in the case of “YES” at step S308), it indicates that vocal reading-out of program information of a program that has been viewed immediately before the input switching is halted in its middle. Thus, at step S309, the program information of the original program is obtained from the storage section 106 again, vocal reading-out thereof is performed at step S310. When no reading halt flag has been stored (in the case of “NO” at step S308), it indicates that the vocal reading-out of the program information of the program that has been viewed immediately before the input switching has not been halted in its middle. Thus, the processing is ended without performing anything.

As described above, according to the digital broadcast reception device 300 of the present embodiment, even in the case where input switching, a kind of interruption operation, occurs and vocal reading-out of program information is temporarily halted, when vocal reading-out of the name of the external device or the external device connection means ends, the vocal reading-out of the program information of the original program can be restarted to prevent missing of any item to be vocally read out.

It is noted that in Embodiment 3 described above, the description has been given on the assumption that a target for restart of program information vocal reading-out of the original program is the entire program information, but as described in the procedure in FIG. 2 in Embodiment 1, items constituting program information may be divided into priority groups and completion of vocal reading-out to any priority group may be a target similarly to Embodiment 2.

### INDUSTRIAL APPLICABILITY

The present invention is widely applicable to not only a digital broadcast reception device but also, for example, an ordinary video device having functionality to display program information of a selected broadcast and vocally read out the displayed program information.

### DESCRIPTION OF THE REFERENCE CHARACTERS

100, 200, 300 digital broadcast reception device
101 reception tuning section
102 signal separation section
103 video decoder section
104 audio decoder section
105 program information selection section
106 storage section
107 additional image generation section
108 additional audio generation section
109 video synthesizing section
110 audio synthesizing section
111 video output section
112 audio output section
113 display section
114 loudspeaker (audio reproduction section)
115 channel selection operation input section
116, 121, 131 control section
120 timer-recording control section
130 inter-device communication control section
310 external device

1. A digital broadcast reception device comprising:
a reception tuning section configured to select a broadcast signal;
a signal separation section configured to separate the selected broadcast signal into program video data, program audio data, and program information data representing program information;
a video decoder section configured to decode the program video data and output a program video signal;
an audio decoder section configured to decode the program audio data and output a program audio signal;
a storage section configured to administer the program information data in a state where a plurality of items in the program information contained in the program information data are classified into a plurality of priority-based groups to which priorities for vocal reading are assigned;
an additional audio generation section configured to generate a reading audio of the program information by using the program information data;
an additional image generation section configured to generate a program information image by using the program information data;
an audio output section configured to output the reading audio of the program information;
a video output section configured to output the program information image;
a channel selection operation input section configured to receive input of a channel selection operation by a user; and
a control section configured to control, when a channel selection operation for switching a currently-viewed program to another program other than the currently-viewed program is inputted into the channel selection operation input section in the middle of vocal reading, from the audio output section, an item in program information contained in program information data of the currently-viewed program, and continuation or halt of output of a reading audio of the item that is being vocally read, in accordance with the priority of the priority-based group to which the item that is being vocally read belongs.

2. The digital broadcast reception device according to claim 1, wherein, while the audio output section vocally reads out an item that belongs to the priority-based group of the priority whose level is equal to or higher than a determined level, the control section performs control so as to hold the channel selection operation to the other program on the channel selection operation input section until vocal reading-out of all items in the priority-based group of the determined priority or higher is ended.

3. The digital broadcast reception device according to claim 1, further comprising a timer-recording control section having timer-viewing functionality or timer-recording functionality, wherein
when, in the middle of vocal reading-out of the program information in the program information data of the currently-viewed program, the currently-viewed program is switched by the timer-recording control section to a program for which timer-viewing is set or a program for which timer-recording is set, the control section temporarily halts the vocal reading-out of the program information in the program information data of the currently-viewed program, and restarts the vocal reading-out of the program information in the program information data of the currently-viewed program after end of vocal reading-out of program information in program information data corresponding to the program for which timer-viewing is set or the program for which timer-recording is set.

4. The digital broadcast reception device according to claim 1, further comprising an inter-device communication control section configured to receive input of a video signal from an external device, wherein
when, in the middle of vocal reading-out of the program information in the program information data of the currently-viewed program, the currently-viewed program is switched by the inter-device communication control section to video based on the video signal from the external device, the control section temporarily halts the vocal reading-out of the program information in the program information data of the currently-viewed program, and restarts the vocal reading-out of the program information in the program information data of the currently-viewed program after end of vocal reading-out of determined information corresponding to the video signal from the external device.

5. A digital broadcast reception method comprising:
a reception tuning step of selecting a broadcast signal;
a signal separation step of separating the broadcast signal into program video data, program audio data, and program information data representing program information;
a storage step of administering the program information data in a state where a plurality of items in the program information contained in the program information data are classified into a plurality of priority-based groups to which priorities for vocal reading are assigned;
an additional audio generation step of generating a reading audio of the program information by using the program information data;
an additional image generation step of generating a program information image by using the program information data;
an audio output step of outputting the reading audio of the program information;
a video output step of outputting the program information image; and
a control step of controlling, when a channel selection operation for switching a currently-viewed program to another program other than the currently-viewed program is inputted in the middle of vocal reading, at the audio output step, an item in program information contained in program information data of the currently-viewed program, continuation or halt of output of a reading audio the item that is being vocally read, in accordance with the priority of the priority-based group to which the item that is being vocally read belongs.

6. The digital broadcast reception method according to claim 5, wherein, during vocal reading-out of an item that belongs to the priority-based group of the priority whose level is equal to or higher than a determined level at the audio output step, the control step performs control so as to hold the channel selection operation to the other program until vocal reading-out of all items in the priority-based group of the determined priority or higher is ended.

7. The digital broadcast reception method according to claim 5, further comprising a timer-recording control step having timer-viewing functionality or timer-recording functionality, wherein
when, in the middle of vocal reading-out of the program information in the program information data of the currently-viewed program, the currently-viewed program is switched at the timer-recording control step to a program for which timer-viewing is set or a program for which timer-recording is set, the control step temporarily halts the vocal reading-out of the program information in the program information data of the currently-viewed program, and restarts the vocal reading-out of the program information in the program information data of the currently-viewed program after end of vocal reading-out of program information in program information data corresponding to the program for which timer-viewing is set or the program for which timer-recording is set.

8. The digital broadcast reception method according to claim 5, further comprising an inter-device communication control step of receiving input of a video signal from an external device, wherein
when, in the middle of vocal reading-out of the program information in the program information data of the currently-viewed program, the currently-viewed program is switched at the inter-device communication control step to the video signal from the external device, the control step temporarily halts the vocal reading-out of the program information in the program information data of the currently-viewed program, and restarts the vocal reading-out of the program information in the program information data of the currently-viewed program after end of vocal reading-out of determined information corresponding to the video signal from the external device.
